(19) United States
(12) Patent Application Publication
(10) Pub. No.: US 2017/0255972 A1
(43) Pub. Date: Sep. 7, 2017

(54) ENHANCEMENT TO CUSTOMER FEEDBACK SYSTEMS

(71) Applicant: CA, Inc., New York, NY (US)

(72) Inventor: Helmar MARTENS, JR., The Colony, TX (US)

(73) Assignee: CA, Inc.

(21) Appl. No.: 15/057,749

(22) Filed: Mar. 1, 2016

(51) Int. Cl. G06Q 30/02; G06F 3/0482; G06F 3/0481

(52) U.S. Cl. CPC G06Q 30/0282; G06F 3/04817; G06F 3/0482

(57) ABSTRACT

A method and non-transitory computer-readable storage medium for executing a method for providing customized feedback forms. The method includes displaying, at a graphical user interface (GUI) of an application, a plurality of icons. Each icon of the plurality of icons includes a unique context ID. The method also includes receiving a selection of a particular one of the plurality of icons, determining a unique context ID associated with the particular one of the plurality of icons, and determining contextual information associated with the particular one of the plurality of icons. The method further includes dynamically assembling, using a processor, a feedback form that is indicative of the determined unique context ID and the contextual information. The feedback form solicits feedback related to the use of the application and specific to the contextual information associated with the particular one of the plurality of icons.

### BACKGROUND

The present disclosure relates to feedback systems and, more specifically, to systems and methods for presenting a user of an application with a customized feedback form.

Conventional feedback systems exist for computer software applications. Typical feedback systems use static and standard feedback forms to collect data from users. Users need to write extensive background information to connect the context and/or activity they were performing with the content of their feedback message when using these static and standard forms. These generic forms may discourage users from providing feedback. These generic forms also may render the feedback message unusable by the product owner because the product owner must interpret where the user was, what they were doing, which feature they are referring to, etc. when the user provided the feedback.

### BRIEF SUMMARY

According to an aspect of the present disclosure, a method may include displaying, at a graphical user interface (GUI) of an application, a plurality of icons. The method also may include receiving a selection of a particular one of the plurality of icons, determining a unique context ID associated with the particular one of the plurality of icons, and determining contextual information associated with the particular one of the plurality of icons. The method may further include dynamically assembling, using a processor, a feedback form that is indicative of the determined unique context ID and the contextual information. The feedback form may be dynamically assembled to solicit feedback related to the use of the application and specific to the contextual information associated with the particular one of the plurality of icons.

The method may further include providing a plurality of predetermined feedback queries with the application, and selectively including particular ones of the plurality of feedback queries that are related to the determined contextual information.

According to another embodiment of the present disclosure, a computer readable storage medium comprising computer-readable program code may be configured to perform the aforementioned method.

According to another embodiment of the present disclosure, a method may include displaying a graphical user interface (GUI) of an application, the GUI including a plurality of selectable icons, wherein the plurality of icons comprises a first icon and a second icon. The method may also include receiving a selection of the first icon, determining a first unique context ID associated with the first icon, and determining first contextual information associated with the first icon. The method may include dynamically assembling, using a processor, a first feedback form that is indicative of the first unique context ID. The method may also include receiving a selection of the second icon, determining a second unique context ID associated with the second icon, and determining second contextual information associated with the second icon. A second feedback form that is indicative of the second unique context ID may be dynamically assembled, using the processor. The first feedback form solicits feedback related to use of the application and specific to the first contextual information associated with the first icon, and the second feedback form solicits feedback specific to the second contextual information associated with the second icon.

Other objects, features, and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements.

FIG. 1 illustrates a schematic representation of a server on which systems and methods for customized feedback may be implemented.

FIG. 2 illustrates a schematic representation of an application for which customized feedback forms may be generated.

FIGS. 3a & 3b illustrate a schematic representation of a customized feedback form.

FIG. 4 illustrates a process for generating customized feedback forms.

FIG. 5 illustrates a schematic representation of how a product owner can configure feedback results.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

While certain example systems and methods disclosed herein may be described with reference to infrastructure management, systems and methods disclosed herein may be related to other areas beyond network infrastructure. Systems and methods disclosed herein may be related to, and used by, any predictive system that utilizes expert learning or other predictive methods. Systems and methods disclosed herein may be applicable to a broad range of applications that, such as, for example, research activities (e.g., research and design, development, collaboration), commercial activities (e.g., sales, advertising, financial evaluation and modeling, inventory control, asset logistics and scheduling), IT systems (e.g., computing systems, cloud computing, network access, security, service provisioning), medicine (e.g., diagnosis or prediction within a particular specialty or sub-specialty), and other activities of importance to a user or organization.

Although feedback systems exist for computer software applications, they do not leverage contextual information to dynamically build a customized feedback form. Existing feedback systems use static and standard feedback forms to collect feedback data from users. The lack of customization requires users to write extensive background information to connect the context and/or activity they were performing with the content of their feedback message making it less likely users will provide feedback. The feedback that is provided is less accurate and not useful to a product owner, or other person reviewing the feedback of the application, if the product owner, or other person reviewing the feedback, is unable to associate the feedback with the specific context.

In view of the foregoing, a need has arisen for ways to provide customized feedback systems for computer software applications in order to improve the volume and usefulness of feedback submitted by a user.

Systems and methods disclosed herein may provide a way to present users with a customized feedback form. In particular, a feedback form may be dynamically populated with data and queries specifically tailored to the context in which the user is operating. Contextual information may be obtained, which is associated with a location or sections of the application in which an icon is located, as well as activities being performed by a user just before an icon is selected, to assemble and provide a feedback form specific to the context of the user within the application.

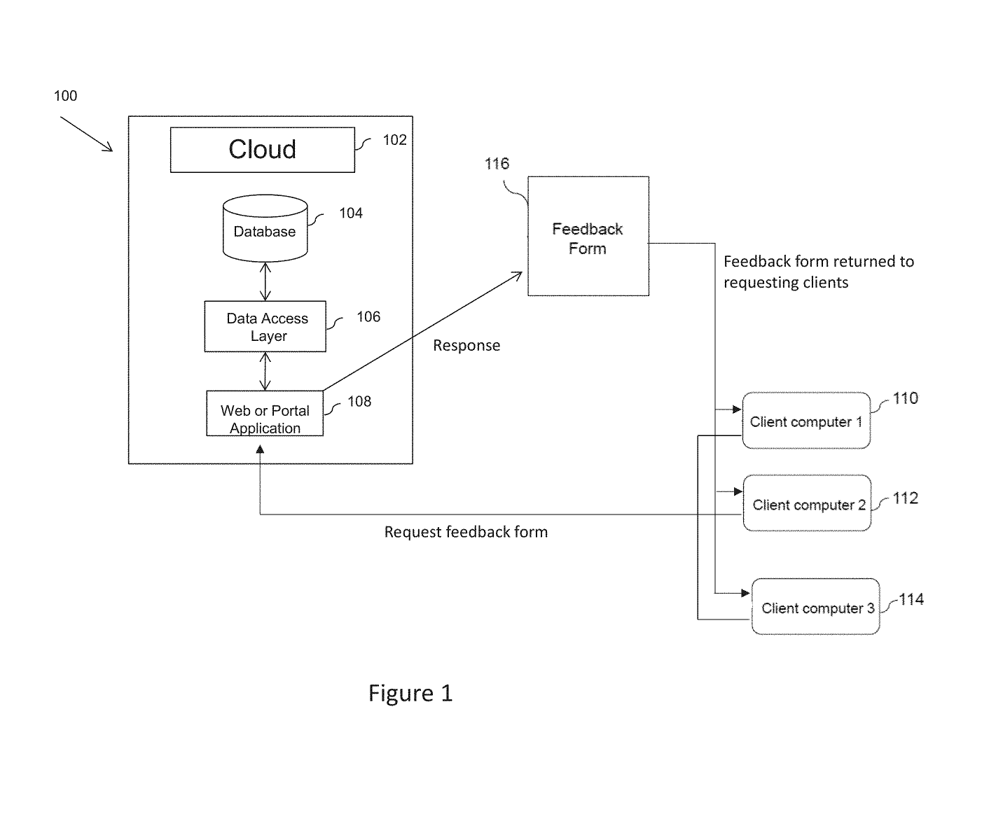

Referring now to FIG. 1, a feedback system 100 according to an inventive embodiment is depicted. Three clients 110, 112, 114, which may be computers, including mobile devices or any other suitable device, are shown interfacing with the feedback system 100. This is exemplary and the feedback system 100 may interface with any suitable number of clients. The client computers 110, 112, 114 may be running a web, desktop, portal, or mobile based application. The feedback system 100 runs a software solution on any suitable web or portal server, including but not limited to an external server or in a cloud computing environment 102 as depicted in FIG. 1.

A processor may provide a software solution that runs in cloud computing environment 102 and communicates with the client computers 110, 112, 114. The application running on the client computer 110, 112, 114 sends a request 108 for a feedback form 116 to the feedback system 100. The request 108 may be in the form of a Uniform Resource Locator (“URL”). The processor running on the cloud computing environment 102 may receive the URL and determine the action to perform based on the URL content. The processor accesses contextual information and feedback queries pre-defined in the database 104 through a data access layer 106. The contextual information in database 104 is associated with a location or section of the application, as well as activities being performed by a user when the user accesses an icon (not shown) to send the request 108 for a feedback form 116. An embodiment of the feedback system 100, shown implemented in a cloud computing environment 102, dynamically builds a feedback form 116 which is customized to the context of the user within the application running on client computer 110, 112, 114. The server side of the feedback system 100 may handle dynamic creation of customized feedback forms. For example, in a software as a service (“SaaS”) solution the server side may be hosted in a cloud environment.

The embodiment of FIG. 1 depicts the feedback system 100 implemented on a cloud computing environment 102 to be offered as a service, such as a software as a service (“SaaS”) solution. This allows for creation of customized feedback forms from anywhere and takes the burden from software makers, who no longer have to create and maintain a database of contextual information to create customized feedback forms. A SaaS implementation may allow different application vendors to subscribe to a cloud solution to provide customized feedback forms for use with each application. However, the software solution that dynamically builds the feedback form 116 may be hosted on any suitable server environment.

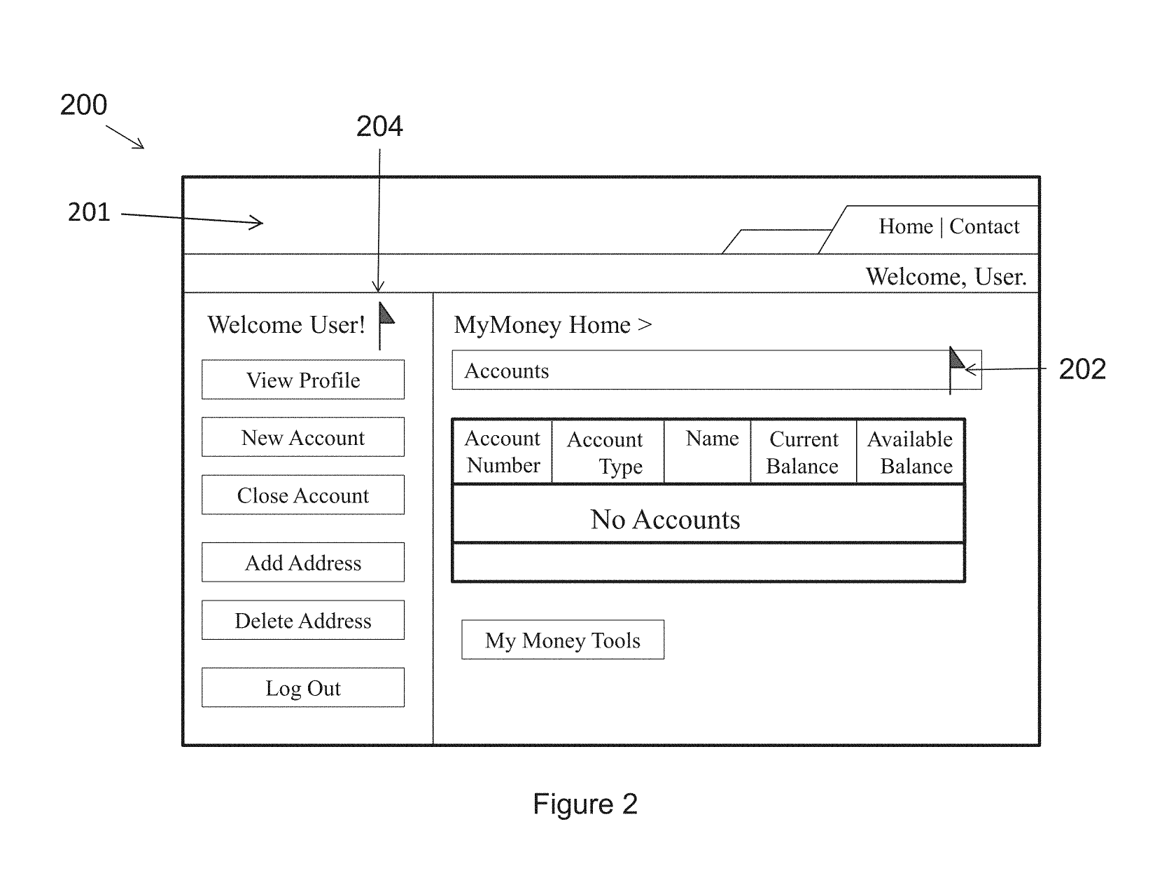

Referring now to FIG. 2, an application 200 according to an inventive embodiment is depicted. Application 200 may be a web, desktop, portal, or mobile based application. The application 200 may include a user interface 201, such as a graphical user interface (GUI) or other suitable display, which presents the application to a user. A plurality of icons are incorporated into the application, such as first icon 202 and second icon 204 in FIG. 2. The icons may be added to different sections or locations within the application. The icons allow a feedback form to be populated with information specific to the location of the icon or activity being performed in the application.

Each icon 202, 204 contains a unique context ID. The unique context ID may be a URL embedded with a unique contextual identifier for each icon 202, 204. For example, icon 202 is associated with a specific section of the application, e.g., the Accounts section as depicted in FIG. 2. When a user of the application 200 clicks an icon, for example icon 202, the application 200 sends a request for a customized feedback form. This request initiates a process of dynamically building the customized feedback form based on the context of the selected icon in the application, such as depicted in FIG. 2. The unique context ID associated with each icon provides a way to correlate the context of the selected icon in the application with the contextual information and feedback queries stored and pre-defined in a database. The icon may be selected by any appropriate user input. The icon may include a selectable region surrounding the icon to allow for a margin of error such that a user does not have to select exactly on the icon.

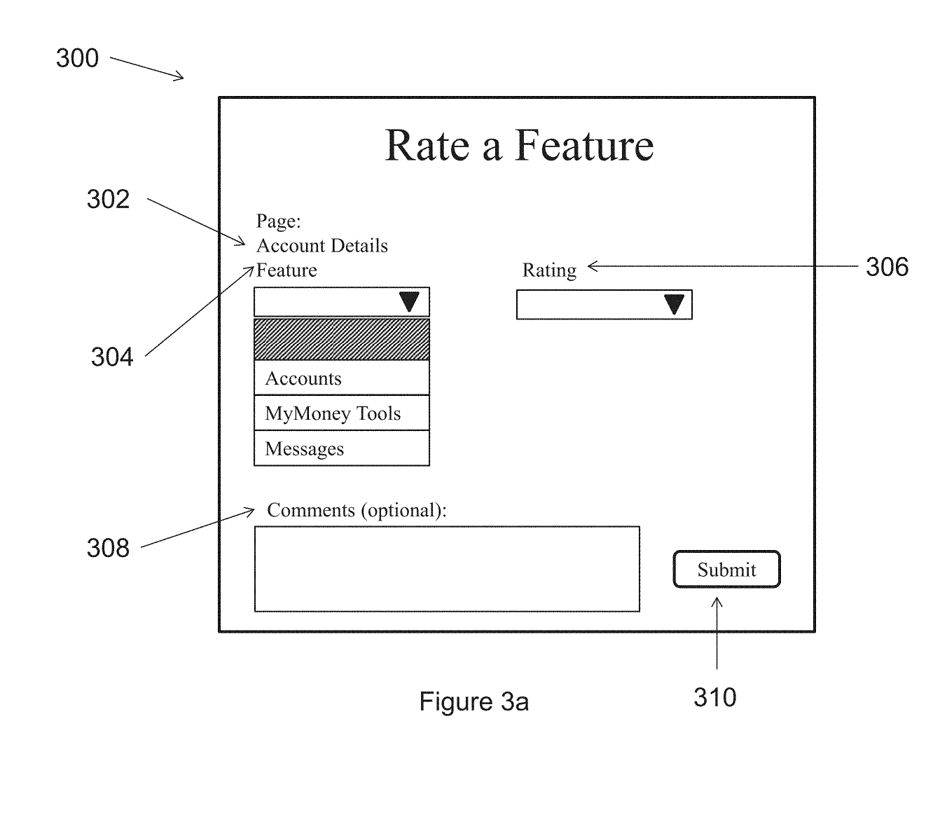

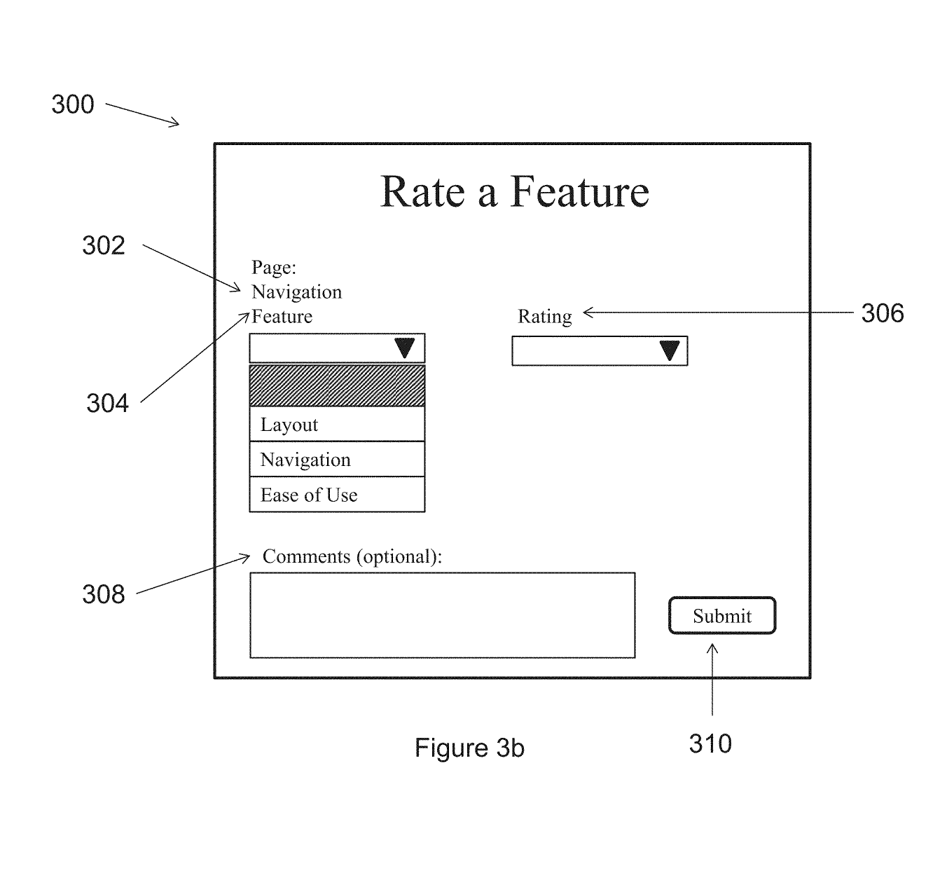

Referring now to FIGS. 3a & 3b, a feedback form 300 is depicted. As shown in FIG. 3a, When a user clicks on, or otherwise selects, an icon, for example icon 202, through the GUI 201 of application 200, the application sends a request for a customized feedback form. Sending the request initiates a process of dynamically building the customized feedback form based on the context of the selected icon in the application. An example context of icon 202 is the Accounts section, as depicted in FIG. 2. Feedback form 300 may be dynamically customized to the Accounts section based on determining the unique context ID associated with icon 202 and determining contextual information associated with the icon 202. Feedback form 300 may contain pre-defined feedback queries 304, 306, 308.

Feedback queries may be predefined by a product owner, or other suitable person, and may be designed to pose questions and solicit feedback concerning specific contexts, such as questions and queries specific to each location, section, or activity being performed by a user of the application. Queries 304, 306, 308 may be dropdown options, check boxes, a comment field, or any other questions soliciting feedback. These feedback forms are dynamically populated with queries related to a determined context. The queries and data are pre-defined in the feedback system, for example by being stored in a memory coupled to the server or the application. The software solution may add other more advanced feedback options. These queries 304, 306, 308 facilitate providing accurate and usable feedback, such as by allowing a user to provide a rating of a particular feature of the application and a space to provide written comments. A button 310 may allow the user to submit the completed feedback form 300.

In the inventive embodiment depicted in FIG. 2, a feedback form 300 created based on the selection of icon 202 would contain different queries 304, 306, 308 than a feedback form 300 created based on the selection of icon 204. For example as shown in FIG. 3a, when icon 202 is selected, the unique context ID and contextual information associated with icon 202 will be determined to be the Accounts section. The feedback form 300 dynamically created based on the selection of icon 202 will be populated with pre-defined feedback queries associated with the Accounts section, as shown in FIG. 3a. As shown in FIG. 3b, when icon 204 is selected, the unique context ID and contextual information associated with icon 204 will be determined to be the Navigation section. The feedback form 300 dynamically created based on the selection of icon 204 will be populated with pre-defined feedback queries associated with the Navigation section, as depicted in FIG. 3b.

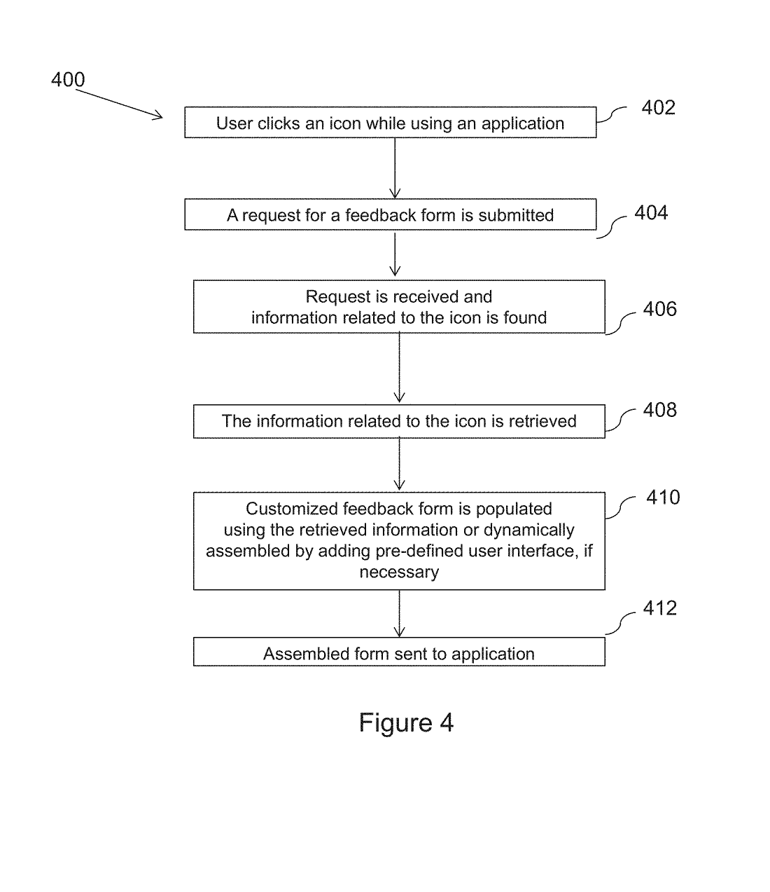

Referring now to FIG. 4, a flow diagram of a process 400 for generating a customized feedback form is depicted. A user clicks an icon, or otherwise selects the icon, while using an application at step 402. At step 404, a request for a customized feedback form is sent to a software solution. At step 406, the software solution receives the request and finds information related to the context of the selected icon based on a unique context ID and contextual information associated with the icon. The software solution retrieves queries which correspond to the unique context ID and contextual information associated with the selected icon at step 408. At step 410 the software solution populates a customized feedback form using the retrieved queries. In this same step, the software solution may dynamically assemble the feedback form by adding pre-defined user interface elements if that is determined to be necessary for the selected context based on determining the context ID. At step 412, the software solution sends the assembled feedback form to the application for the user to provide feedback.

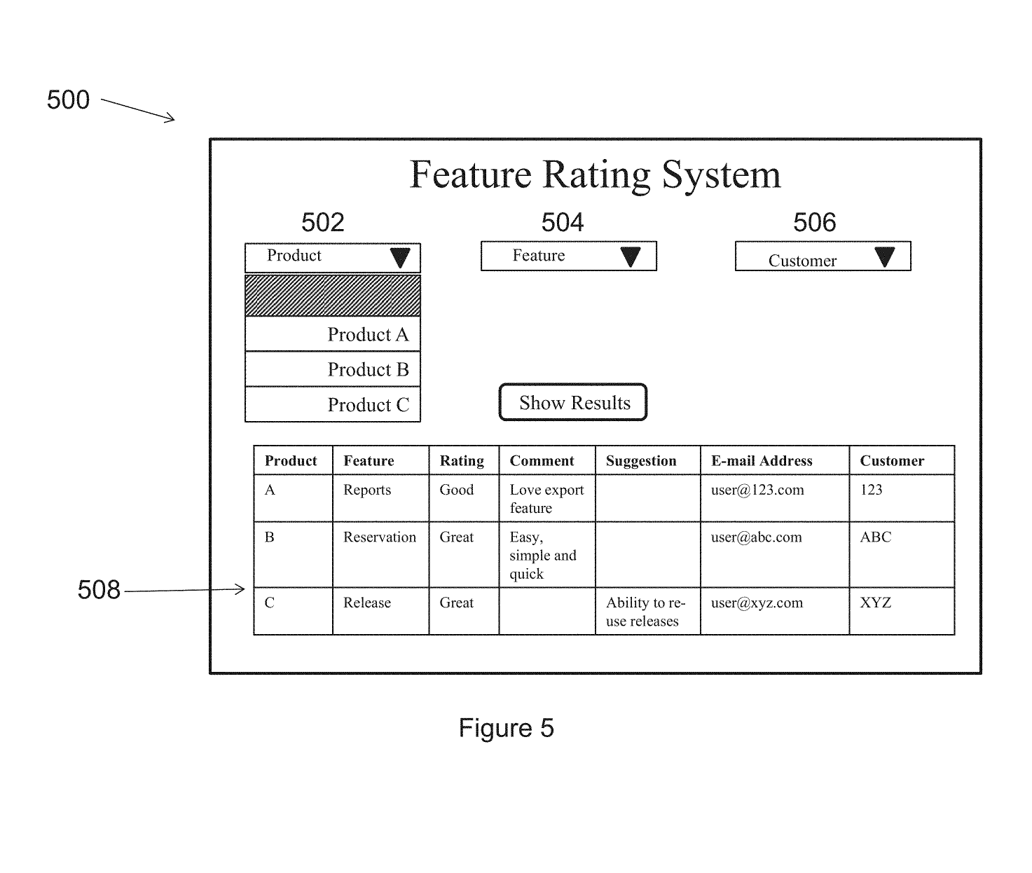

Referring now to FIG. 5, a feature rating system 500 according to an inventive embodiment is depicted. The feature rating system 500 allows a product owner of the application to have access to more accurate feedback data and to organize received feedback data. The feature rating system 500 allows the product owner to sort and view the feedback by a variety of bases. These bases may include any of the criteria used to identify a feedback item, including but not limited to product, feature, customer, rating, comments, suggestion, submitter, etc. The product owner searches the feedback through elements such as drop down menus 502, 504, 506. The product owner may also search feedback items through a free format search input element (not shown). The results 508 are displayed to the product owner to allow the product owner to view selected feedback.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
displaying, at a graphical user interface (GUI) of an application, a plurality of icons;
receiving a selection of a particular one of the plurality of icons;
determining a unique context ID associated with the particular one of the plurality of icons;
determining contextual information associated with the particular one of the plurality of icons;
dynamically assembling, using a processor, a feedback form that is indicative of the determined unique context ID and the contextual information; and
wherein the feedback form solicits feedback related to use of the application and specific to the contextual information associated with the particular one of the plurality of icons.

2. The method of claim 1, further comprising:
displaying the feedback form to a user of the application;
receiving feedback from the user, the feedback having been entered into the feedback form by the user;
associating the feedback with the unique context ID; and
storing the feedback in a memory.

3. The method of claim 1, wherein the plurality of icons comprises a first icon and a second icon, the particular one of the plurality of icons comprises the first icon, the unique context ID comprises a first unique context ID, the contextual information comprises first contextual information and the feedback form comprises a first feedback form, and further comprising:
receiving a selection of the second icon;
determining a second unique context ID associated with the second icon, the second unique context ID being different than the first unique context ID;
determining second contextual information associated with the second icon, the second contextual information being different than the first contextual information;
dynamically assembling, using the processor, a second feedback form that is indicative of the second unique context ID and the second contextual information; and
wherein the second feedback form solicits feedback related to the use of the application and specific to the second contextual information associated with the second icon.

4. The method of claim 1, wherein the contextual information is directly related to the location of the particular one of the plurality of icons within the GUI of the application.

5. The method of claim 1, wherein the contextual information comprises an activity that a user of the application was engaged in just prior to selecting the particular one of the plurality of icons.

6. The method of claim 1, wherein dynamically assembling the feedback form comprises:
supplying a plurality of predetermined feedback queries with the application; and
selectively including particular ones of the plurality of feedback queries that are related to the contextual information.

7. The method of claim 1, wherein dynamically assembling the feedback form comprises:
accessing data applicable to the particular one of the plurality of icons;
retrieving the data applicable to the particular one of the plurality of icons; and
populating the feedback form using the retrieved data.

8. A method, comprising:
displaying a graphical user interface (GUI) of an application, the GUI including a plurality of selectable icons, wherein the plurality of icons comprises a first icon and a second icon;
receiving a selection of the first icon;
determining a first unique context ID associated with the first icon;
determining first contextual information associated with the first icon;
dynamically assembling, using a processor, a first feedback form that is indicative of the first unique context ID;
receiving a selection of the second icon;
determining a second unique context ID associated with the second icon;
determining second contextual information associated with the second icon;
dynamically assembling, using the processor, a second feedback form that is indicative of the second unique context ID; and
wherein the first feedback form solicits feedback related to use of the application and specific to the first contextual information associated with the first icon, and the second feedback form solicits feedback specific to the second contextual information associated with the second icon.

9. The method of claim 8, wherein the first contextual information comprises a section or area of the application in which the first icon is located, wherein the second contextual information comprises a section or area of the application in which the second icon is located, and wherein the first icon and the second icon are located in different sections or areas of the application.

10. The method of claim 8, wherein first contextual information comprises an activity of the first being performed just before the selection of the first icon, wherein the second contextual information comprises a second activity being performed just before the selection of the second icon, and wherein the first activity and second activity are different.

11. The method of claim 8, wherein dynamically assembling the first feedback form comprises:
accessing data applicable to the first icon;
retrieving the data applicable to the first icon; and
populating the feedback form using the retrieved data.

12. The method of claim 8, wherein dynamically assembling the second feedback form comprises:
accessing data applicable to the second icon;
retrieving the data applicable to the second icon; and
populating the feedback form using the retrieved data.

13. The method of claim 8, further comprising:
storing a plurality of predetermined feedback queries in a memory.

14. The method of claim 13, wherein dynamically assembling the first feedback form comprises:
selectively including particular ones of the plurality of feedback queries that are related to the first contextual information; and
wherein dynamically assembling the second feedback form comprises:
selectively including particular ones of the plurality of feedback queries that are related to the second contextual information.

15. A non-transitory computer-readable storage medium, comprising computer-executable instructions carried on the computer-readable storage medium, the instructions readable by a processor and, when read and executed, configured to cause the processor to:
display a graphical user interface (GUI) of an application, the GUI including a plurality of selectable icons to provide feedback regarding the application, wherein at least one icon of the plurality of icons includes a unique context ID;
receive a selection of a particular one of the plurality of icons;
determine the unique context ID of the particular one of the plurality of icons;
determine contextual information associated with the particular one of the plurality of icons;
dynamically assemble a feedback form that is indicative of the particular one of the plurality of icons.

16. The non-transitory computer-readable storage medium of claim 15, wherein the feedback form is dynamically assembled to solicit feedback related to the use of the application and specific to the contextual information associated with the particular one of the plurality of icons.

17. The non-transitory computer-readable storage medium of claim 15, wherein the application comprises a plurality of predetermined feedback queries, and wherein the instructions to dynamically assemble the feedback form comprises:
selectively include particular ones of the plurality of feedback queries that are related to the contextual information.

18. The non-transitory computer-readable storage medium of claim 15, wherein instructions further comprise:
display the feedback form to a user of the application;
receive feedback from the user, the feedback having been entered into the feedback form by the user;
associate the feedback with the unique context ID; and
store the feedback in a memory.

19. The non-transitory computer-readable storage medium of claim 15, wherein the contextual information is related to an activity being performed by a user just before the selection of the particular one of the plurality of icons.

20. The non-transitory computer-readable storage medium of claim 15, wherein the instruction to dynamically assemble the feedback form comprise instructions readable by a processor and, when read and executed, configured to cause the processor to:
access data applicable to the selected icon of the plurality of icons;
retrieve the data applicable to the selected icon; and
populate the feedback form using the retrieved data.
